(19) United States
(12) Patent Application Publication
(10) Pub. No.: US 2023/0141589 A1
(43) Pub. Date: May 11, 2023

(54) APPARATUS AND METHODS FOR PROVIDING CLOUD-BASED VERIFICATION OF EDGE-BASED DETECTIONS

(71) Applicant: HERE GLOBAL B.V., Eindhoven (NL)

(72) Inventors: Leon Stenneth, Chicago, IL (US); Jeremy Michael Young, Chicago, IL (US); Jerome Beaurepaire, Berlin (DE)

(73) Assignee: HERE GLOBAL B.V., EINDHOVEN (NL)

(21) Appl. No.: 17/523,623

(22) Filed: Nov. 10, 2021

(51) Int. Cl. H04L 29/08

(52) U.S. Cl. CPC H04L 67/10

(57) ABSTRACT

An apparatus, method and computer program product are provided for providing cloud-based verification of edge-based detection. In one example, the apparatus generates a result of sensor data, wherein the sensor data is acquired by a sensor of an edge-based device, and wherein the result is processed by the edge-based device. The result indicates: (i) a confidence at which the sensor data is classified as a category; (ii) a degree at which the sensor data differ from a data point of map data, the data point associated with a location in which the sensor data was acquired; or (iii) a combination thereof. The apparatus causes a cloud-based device to process the sensor data in response to: (i) the confidence indicating uncertainty; (ii) the degree exceeding a threshold; or (iii) a combination thereof.

### TECHNICAL FIELD

The present disclosure generally relates to the field of edge and cloud computing, associated methods and apparatus, and in particular, concerns, for example, an apparatus configured to provide cloud-based verification of edge-based detection based on an edge-based detection result or one or more predetermined conditions.

### BACKGROUND

Vehicles include on-board computing platforms for classifying sensor data as one or more categories. For example, image data including images of a road lane marking may be processed by the on-board computing platforms and classified as a type of road lane marking; however, since the computing capabilities of the vehicles are limited to the specification of the on-board computing platforms, the software for classifying the images may be outdated, and the likelihood of misclassifying the images may increase over time.

The listing or discussion of a prior-published document or any background in this specification should not necessarily be taken as an acknowledgement that the document or background is part of the state of the art or is common general knowledge.

### BRIEF SUMMARY

According to a first aspect, an apparatus comprising at least one processor and at least one non-transitory memory including computer program code instructions is described. The computer program code instructions, when executed, cause the apparatus to generate a result of sensor data, wherein the sensor data is acquired by a sensor of an edge-based device, and wherein the result is processed by the edge-based device, the result indicating: (i) a confidence at which the sensor data is classified as a category; (ii) a degree at which the sensor data differ from a data point of map data, the data point associated with a location in which the sensor data was acquired; or (iii) a combination thereof. The computer program code instructions, when executed, further cause the apparatus to, responsive to: (i) the confidence indicating uncertainty; (ii) the degree exceeding a threshold; or (iii) a combination thereof, cause a cloud-based device to process the sensor data.

According to a second aspect. a non-transitory computer-readable storage medium having computer program code instructions stored therein is described. The computer program code instructions, when executed by at least one processor, cause the at least one processor to acquire sensor data at an edge-based device equipped with a sensor; determine: (i) a location of the edge-based device; (ii) a weather condition impacting or predicted to impact the edge-based device; (iii) a time at which the edge-based device requests sensor data acquired by the sensor to be processed; or (iv) a combination thereof; and responsive to: (i) the edge-based device encountering a portion of a road having predetermined attributes; (ii) the weather condition being a predetermined weather condition; (iii) the time being within a period of a day that is classified as lacking natural light; or (iv) a combination thereof, cause a cloud-based device to process the sensor data.

According to a third aspect, a method of transitioning sensor-based computations between an edge-based vehicle and a cloud-based device is described. The method includes receiving a route of the edge-based vehicle equipped with a sensor; and causing a transition of computation of sensor data acquired by the sensor from the edge-based vehicle to the cloud-based device based on: (i) a geographical change within the route; (ii) a weather condition associated with the route; (iii) an amount of light estimated to be impacting the route; or (iv) a combination thereof.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

The steps of any method disclosed herein do not have to be performed in the exact order disclosed, unless explicitly stated or understood by the skilled person.

Corresponding computer programs (which may or may not be recorded on a carrier) for implementing one or more of the methods disclosed herein are also within the present disclosure and encompassed by one or more of the described example embodiments.

The present disclosure includes one or more corresponding aspects, example embodiments or features in isolation or in various combinations whether or not specifically stated (including claimed) in that combination or in isolation. Corresponding means for performing one or more of the discussed functions are also within the present disclosure.

### BRIEF DESCRIPTION OF THE DRAWINGS

The embodiments of the invention are illustrated by way of example, and not by way of limitation, in the figures of the accompanying drawings:

FIG. 1A illustrates a diagram of a system capable of providing cloud-based verification of edge-based detection;

FIG. 1B illustrates a diagram of the database within the system of FIG. 1A;

FIG. 2 illustrates a diagram of the components of the cloud-based platform within the system of FIG. 1A;

FIG. 3 illustrates an example scenario in which the calculation module of FIG. 2 generates a data point associated with a request for cloud-based verification of edge-based detection;

FIG. 4 illustrates an example visual representation rendered by the presentation module of FIG. 2.

FIG. 5 illustrates a flowchart of a process for causing a cloud-based device to process sensor data based on a result output by an edge-based device;

FIG. 6 illustrates a flowchart of a process for causing a cloud-based device to process sensor data based on one or more environmental conditions;

FIG. 7 illustrates a computer system upon which an embodiment may be implemented;

FIG. 8 illustrates a chip set or chip upon which an embodiment may be implemented; and

FIG. 9 illustrates a diagram of exemplary components of a mobile terminal for communications, which is capable of operating in the system of FIG. 1A.

### DETAILED DESCRIPTION

Vehicles are equipped with on-board computing platforms for classifying sensor data as one or more categories. For example, vehicle cameras may acquire images at a road segment including road works, and the on-board computing platform may process the images to identify one or more road objects, such as traffic cones, barriers, etc. By way of another example, a vehicle may be equipped with external sound recorders and capture sound generated from a nearby event occurring in a stadium, and the on-board computing platform may process audio data corresponding to the sound and determine that a sporting event is occurring proximate to the vehicle. The on-board computing platforms provides an advantage in a way that sensor data acquired via vehicle sensor can be directly provided to an on-board computing platform; however, the drawback of solely relying on the on-board computing platform for classifying sensor data is that the capability for computing the sensor data is limited to the specifications of the on-board computing platform. As such, sensor data classification via the on-board computing platform is subject to error and uncertainty. Additionally, such classification can be further challenging when sensor data are acquired at locations associated with certain geographic attributes and environmental attributes. Therefore, there is a need to remedy these issues.

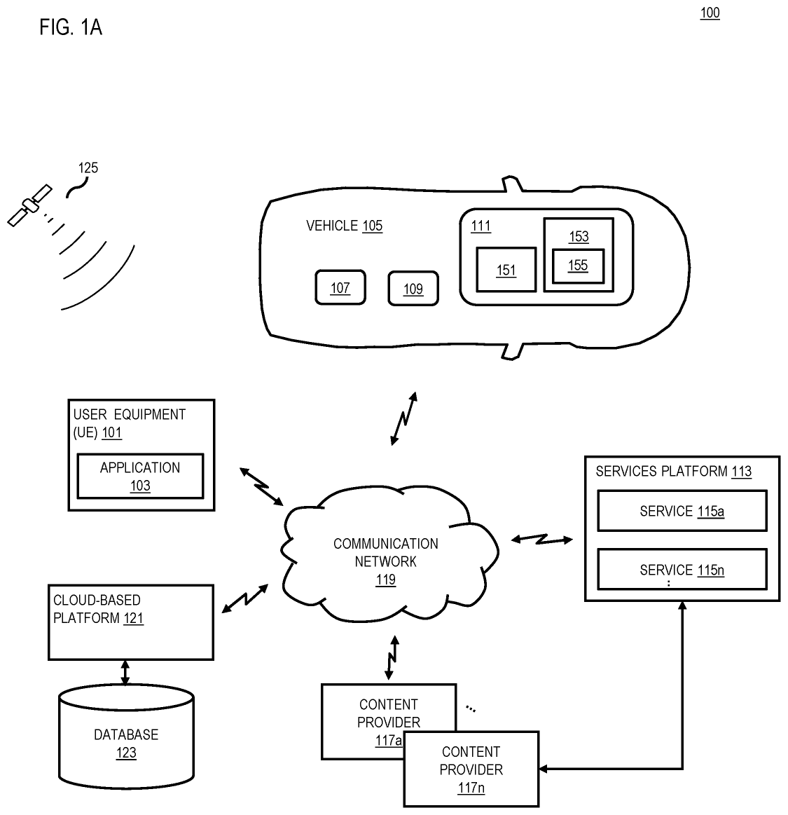

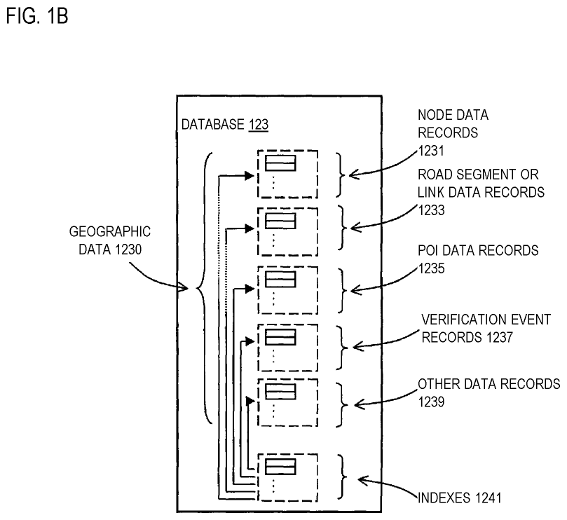

FIG. 1A is a diagram of a system 100 capable of providing cloud-based verification of edge-based detection. Herein, an edge-based detections refer to acquiring sensor data via sensors equipped by an edge-based device (e.g., a vehicle) and classifying the sensor data via an on-board computing platform of the edge-based device. A cloud-based verification refers to classifying sensor data acquired by an edge-based device via one or more cloud-based devices. In the illustrated embodiment, the system includes a user equipment (UE) 101, a vehicle 105, services platform 113, content providers 117a-117n, a communication network 119, a cloud-based platform 121, a database 123, and a satellite 125. Additional or a plurality of mentioned components may be provided.

In the illustrated embodiment, the system 100 comprises a user equipment (UE) 101 that may include or be associated with an application 103. In one embodiment, the UE 101 has connectivity to the cloud-based platform 121 via the communication network 119. The cloud-based platform 121 performs one or more functions associated with providing cloud-based verification of edge-based detection. In the illustrated embodiment, the UE 101 may be any type of mobile terminal or fixed terminal such as a mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, a user-interface or device associated with or integrated with one or more vehicles 105, or any combination thereof, including the accessories and peripherals of these devices. In one embodiment, the UE 101 can be a navigation system, a personal navigation device (PND), a portable navigation device, a cellular telephone, a mobile phone, a personal digital assistant (PDA), a watch, a camera, a computer, etc. In one embodiment, the one or more vehicles may have cellular or Wi-Fi connection either through the inbuilt communication equipment or from the UE 101 associated with the vehicles. It should be appreciated that the UE 101 can support any type of interface to the user (such as “wearable” devices, etc.).

In the illustrated embodiment, the application 103 may be any type of application that is executable by the UE 101, such as a navigation application, a mapping application, a location-based service application, a content provisioning service, a camera/imaging application, a media player application, a social networking application, a calendar application, or any combination thereof. In one embodiment, one of the applications 103 at the UE 101 may act as a client for the cloud-based platform 121 and perform one or more functions associated with the functions of the cloud-based platform 121 by interacting with the cloud-based platform 121 over the communication network 119. In one embodiment, a user may access the application 103 through the UE 101 for performing functions associated with the cloud-based platform 121 and/or receiving information regarding the functions. In one embodiment, the application 103 may assist in conveying information regarding cloud-based verification of edge-based detections.

The vehicle 105 may be a standard gasoline powered vehicle, a hybrid vehicle, an electric vehicle, a fuel cell vehicle, and/or any other mobility implement type of vehicle. The vehicle 105 includes parts related to mobility, such as a powertrain with an engine, a transmission, a suspension, a driveshaft, and/or wheels, etc. The vehicle 105 may be a manually controlled vehicle, semi-autonomous vehicle (e.g., some routine motive functions, such as parking, are controlled by the vehicle 105), or an autonomous vehicle (e.g., motive functions are controlled by the vehicle 105 without direct driver input).

The autonomous level of a vehicle can be a Level 0 autonomous level that corresponds to no automation for the vehicle, a Level 1 autonomous level that corresponds to a certain degree of driver assistance for the vehicle, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle. In one embodiment, the UE 101 may be integrated in the vehicle 105, which may include assisted driving vehicles such as autonomous vehicles, highly assisted driving (HAD), and advanced driving assistance systems (ADAS). Any of these assisted driving systems may be incorporated into the UE 101. Alternatively, an assisted driving device (not illustrated) may be included in the vehicle 105. The assisted driving device may include memory, a processor, and systems to communicate with the UE 101.

The term autonomous vehicle may refer to a self-driving or driverless mode in which no passengers are required to be on board to operate the vehicle. An autonomous vehicle may be referred as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate and respond to lane marking indicators (lane marking type, lane marking intensity, lane marking color, lane marking offset, lane marking width, or other characteristics) and driving commands or navigation commands.

In one embodiment, the vehicle 105 may be an HAD vehicle or an ADAS vehicle. An HAD vehicle may refer to a vehicle that does not completely replace the human operator. Instead, in a highly assisted driving mode, the vehicle may perform some driving functions and the human operator may perform some driving functions. Vehicles may also be driven in a manual mode in which the human operator exercises a degree of control over the movement of the vehicle. The vehicles may also include a completely driverless mode. Other levels of automation are possible. The HAD vehicle may control the vehicle through steering or braking in response to the on the position of the vehicle and may respond to lane marking indicators (lane marking type, lane marking intensity, lane marking color, lane marking offset, lane marking width, or other characteristics) and driving commands or navigation commands. Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) and driving commands or navigation commands.

In this illustrated example, the vehicle 105 includes a plurality of sensors 107, an on-board communications platform 109, and an on-board computing platform 111. The sensors 107 may include image sensors (e.g., electronic imaging devices of both analog and digital types, which include digital cameras, camera modules, camera phones, thermal imaging devices, radar, sonar, lidar, etc.), a global positioning sensor for gathering location data, a signal detection sensor for detecting wireless signals or receivers for different short-range communications (e.g., Bluetooth, Wi-Fi, Li-Fi, near field communication (NFC), etc.), temporal information sensors, audio recorders for converting sound to sound data, velocity sensors, light sensors, oriental sensors augmented with height sensor and acceleration sensor, tilt sensors to detect the degree of incline or decline of the vehicle 105, etc. In a further embodiment, sensors 107 about the perimeter of the vehicle 105 may detect the relative distance of the vehicle 105 from objects such as light beams, vehicles, aircrafts, POIs, establishments, stationary sensory devices within an area, road objects (e.g., road markings or landmarks), lanes, or roadways, pedestrians, traffic lights, road features (e.g., curves) and any other objects, or a combination thereof. In one embodiment, the vehicle 105 may include GPS receivers to obtain geographic coordinates from satellites 125 for determining current location and time associated with the vehicle 105. Further, the location can be determined by a triangulation system such as A-GPS, Cell of Origin, or other location extrapolation technologies.

The on-board communications platform 109 includes wired or wireless network interfaces to enable communication with external networks. The on-board communications platform 109 also includes hardware (e.g., processors, memory, storage, antenna, etc.) and software to control the wired or wireless network interfaces. In the illustrated example, the on- board communications platform 109 includes one or more communication controllers (not illustrated) for standards-based networks (e.g., Global System for Mobile Communications (GSM), Universal Mobile Telecommunications System (UMTS), Long Term Evolution (LTE) networks, 5G networks, Code Division Multiple Access (CDMA), WiMAX (IEEE 802.16m); NFC; local area wireless network (including IEEE 802.11 a/b/g/n/ac or others), dedicated short range communication (DSRC), and Wireless Gigabit (IEEE 802.11ad), etc.). In some examples, the on-board communications platform 109 includes a wired or wireless interface (e.g., an auxiliary port, a Universal Serial Bus (USB) port, a Bluetooth® wireless node, etc.) to communicatively couple with the UE 101.

The on-board computing platform 111 performs one or more functions associated with the vehicle 105. For example, such functions be defined, at least in part, by algorithms/data for providing mobility for the vehicle 105, algorithms/data for processing sensor data acquired by the sensors 107 (e.g., image classification, audio classification, etc.), algorithms/data for performing localization based on the sensor data and other data (e.g., map data) received from other entities/components within the system 100. In one embodiment, the on-board computing platform 109 may aggregate sensor data generated by at least one of the sensors 107 and transmit the sensor data via the on-board communications platform 109. The on-board computing platform 111 may receive control signals and/or other signals for performing one or more of the functions associated with the cloud-based platform 121, the UE 101, the services platform 113, one or more of the content providers 117a-117n, or a combination thereof via the on-board communications platform 109. The on-board computing platform 111 includes a processor 151 and memory 153. The processor 151 may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory 153 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, non-volatile solid-state memory, etc.), unalterable memory (e.g., EPROMs), read-only memory, and/or high-capacity storage devices (e.g., hard drives, solid state drives, etc). In some examples, the memory includes multiple kinds of memory, particularly volatile memory and non-volatile memory.

The memory 153 includes a data manager 155 that can be executed via the processor 151 for performing various functions. The data manager 155 is capable of: (1) acquiring sensor data from the sensors 107; (2) processing the sensor data; and (3) determining whether one or more predetermined conditions is satisfied for causing the on-board communication platform 109 to transmit the sensor data to the cloud-based platform 121 for cloud-based verification. While the illustrated embodiment depicts the data manager 155 as being part of software stored in the memory 153, it is contemplated that, in alternative embodiments, the data manager 155 may embody a combination of hardware and software available within the on-board computing platform 111. In one embodiment, software defining the data manager 155 may be provided by the cloud-based platform 121. As such, other vehicles similar to the vehicle 105 may also download the software to perform one or more functions associated with the data manager 155 for said vehicles.

The sensor data manger 155 is capable of classifying certain data/portions/components/objects defined in the sensor data as one or more categories that can be discerned by a machine, a human, or a combination thereof. For example, if the sensor data manger 155 is performing image classification, the data manager 155 may identify portions of image data acquired via one or more of the sensors 107 (i.e., one or more image sensors) as a stop sign, a traffic light, lane markings, etc. By way of another example, if the data manager 155 is performing audio classification, the sensor data manger 155 may identify portions of audio data acquired via one or more of the sensors 107 (i.e., audio recorders) as a type of music, a sound of a sporting event, an animal sound, etc. In one embodiment, the data manager 155 may embody a machine learning model for classifying sensor data, where the machine learning model is trained by using data that correlate sensor data to discernible categories.

In one embodiment, for each classification of sensor data, the data manager 155 may generate a confidence value of a classification result. The confidence value indicates a confidence at which a specific portion of the sensor data is classified as a discernible category (i.e., a degree at which the portion of the sensor data corresponds to the discernible category). In one embodiment, for each classification of sensor data, the data manager 155 acquires a classification result including one or more categories corresponding to the sensor data and compare the classification result to one or more attributes of map data corresponding to the location in which the sensor data was acquired. In one embodiment, the one or more attributes may indicate one or more geographic attributes within the location. For example, a geographic attribute may indicate: (1) a traffic-based object (e.g., a road sign, road barriers, road markings, traffic lights, etc.) and one or more attributes associated therewith (e.g., information presented by the traffic-base object, size, dimension, orientation, shape, etc.); (2) a non-traffic-based object (e.g., a street light, a bus stop, a mailbox, etc.) and one or more attributes associated therewith (e.g., size, dimension, orientation, shape, etc.); or (3) a point-of-interest (P01) and one or more attributes associated therewith (e.g., size, dimension, orientation, shape, etc.). In one embodiment, the one or more attributes may indicate that the location is known to generate a certain sound (e.g., a type of music) at a certain time of day. When the data manager 155 determines the one or more attributes of the map data, the data manager 155 determines a degree at which the one or more attributes of the map data corresponds to the one or more categories of the classification result. For example, the data manager 155 may classify an object within images acquired by image sensors of the sensors 107 as a stop sign and compare one or more attributes of the stop sign acquired from the images with one or more attributes of a stop sign as defined in map data corresponding to the location in which the images were acquired. By way of another example, the data manager 155 may classify audio data acquired by sound recorders of the sensors 107 at a location as a bird sound and compare one or more attributes of the bird sound acquired from the audio data with map data that associates the location with a sound event in which a specific type of bird sound is frequently generated.

In one embodiment, the data manager 155: (1) determines whether one or more predetermined conditions is satisfied; and (2) if the one or more predetermined conditions is satisfied, causes the on-board communication platform 109 to transmit the sensor data to the cloud-based platform 121 for cloud-based verification. In one embodiment, one of the predetermined conditions is defined by an event in which a confidence value of a classification result is within a predetermined range. The predetermined range indicates that the data manager 155 is uncertain whether a specific portion of sensor data classifies as a discernible category. For example, if the confidence value of the classification result is within 55% to 70%, the data manager 155 is uncertain whether the specific portion of sensor data classifies as the discernible category. In one embodiment, another predetermined condition is defined by an event in which a delta between edge-based detection and map data is substantial. Specifically, the predetermined condition is defined by an event in which a difference between a classification result of sensor data and one or more attributes of map data corresponding to a location in which the sensor data was acquired is greater than a threshold. For example, the predetermined condition may be defined by an event in which: (1) the data manager 155 classifies a road sign within images acquired by image sensors of the sensors 107 as a speed limit sign of 50 kph; and (2) the data manager 155 determines that map data indicates a speed limit sign of 100 kph at the location in which the images were acquired. It should be appreciated that a delta between an edge-based detection and map data is not limited to information displayed on road signs; the delta may also be defined by other attributes, such as shape, size, orientation, color, sound type, etc.

The predetermined conditions for transmitting sensor data to the cloud-based platform 121 are not limited to classification results. In one embodiment, the data manager 155 may acquire route information indicating a route of the vehicle 105 or determine a current road segment or one or more subsequent road segments that the vehicle 105 is predicted to traverse. Using map data, the data manager 155 may determine whether the route includes a predetermined road segment or the current road segment or a subsequent road segment is the predetermined road segment. The predetermined road segment may be a road segment including a complex road geometry, such as an intersection, a ramp, or a parallel road arrangement. If the route includes the predetermined road segment or the current road segment or a subsequent road segment is the predetermined road segment, the data manager 155 may cause the on-board communication platform 109 to transmit sensor data to the cloud-based platform 121 for cloud-based verification. In one embodiment, the predetermined road segment is a road segment that is being impacted by an adverse weather condition or predicted to be impacted by an adverse weather condition (e.g., fog, heavy rain, snowstorm, etc.). In such embodiment, the data manager 155 identifies the predetermined road segment by using map data, weather forecast data, sensor data or a combination thereof. In one embodiment, one of the predetermined conditions may be an event in which the data manager 155 determines that an amount of light impacting a location of the vehicle 105 is below a threshold. In such embodiment, the threshold may define a transition between daytime and night-time. In such embodiment, the data manager 155 may determine the amount of light based on a current time and historical data indicating past periods of transition between daytime and night-time for the location of the vehicle 105. Alternatively, the data manager 155 may use the sensors 107 to detect the amount of light and determine whether the vehicle 105 is traveling during night-time based on the detected amount of light. Alternatively, the data manager 155 may: (1) determine a current location of the vehicle 105; (2) determine a current time; (3) use an algorithm to calculate a sun angle as a function of the current time and the current location; and (4) determine whether the vehicle 105 is traveling during daytime or night-time based on the sun angle. In one embodiment, one of the predetermined conditions may be defined by an event in which the vehicle 105 reaches the end of a road segment or a road link. In such embodiment, if the vehicle 105 reaches the end of a road segment or a road link, the data manager 155 may cause the on-board communication platform 109 to transmit sensor data to the cloud-based platform 121 for cloud-based verification. In one embodiment, one of the predetermined conditions is defined by an event in which the vehicle 105 crosses one or more geofences defined within map data. The one or more geofences may be an indicator that cloud-based verification should be performed by the cloud-based platform 121 when a vehicle enters one or more areas defined by the one or more geofences.

In one embodiment, the data manager 155 may cause the on-board communication platform 109 to transmit sensor data to the cloud-based platform 121 for cloud-based verification periodically. For example, the sensor data may be transmitted to the cloud-based platform 121 for cloud-based verification every 2 minutes. In one embodiment, the data manager 155 may cause the on-board communication platform 109 to transmit sensor data to the cloud-based platform 121 for cloud-based verification after a random amount of time has elapsed. In one embodiment, the data manager 155 may prevent the on-board communication platform 109 to transmit sensor data to the cloud-based platform 121 for cloud-based verification if an amount of period starting from a prior session of transmitting sensor data for cloud-based verification has not exceeded a threshold amount of time. For example, if: (1) the on-board communication platform 109 has transmitted sensor data to the cloud-based platform 121 for cloud-based verification at a time point; and (2) a period starting from the time point does not exceed 10 minutes, the data manager 155 prevents the on-board communication platform 109 from executing a subsequent session of transmitting sensor data to the cloud-based platform 121 for cloud-based verification until the period exceeds 10 minutes.

In one embodiment, for each instance in which the data manager 155 relies on the cloud-based platform 121 for cloud-based verification of sensor data acquired by the sensors 107, the data manager 155 defines a minimum turnaround period for the cloud-based verification. If the cloud-based platform 121 takes longer than the minimum turnaround period to provide the cloud-based verification, the data manager 155 ignores the request for the cloud-based verification and solely relies on the edge-based detection performed by the vehicle 105. In such embodiment, the minimum turnaround period is provided to ensure that the vehicle 105 has enough time to provide a response based on a classification of the sensor data. For example, the vehicle 105 may require a classification of images acquired via the sensors 107 to be executed in a short amount of time to provide reliable lane detection and autonomous driving. In one embodiment, the data manager 155 may reject results of cloud-based verification of sensor data acquired by the vehicle 105 if: (1) the confidence value of the classification result performed by the cloud-based platform 121 is within the predetermined range indicating uncertainty (e.g., 55% to 70%); (2) the confidence value of the classification result performed by the cloud-based platform 121 is less than the confidence value of the classification result output by the data manager 155; or (3) a combination thereof.

The services platform 113 may be an original equipment manufacturer (OEM) platform that provides one or more services 115a-115n (collectively referred to as services 115). In one embodiment, the one or more services 115 may be sensor data collection services. By way of example, sensor data acquired by the sensors 107 may be transferred to the UE 101, the cloud-based platform 121, the database 123, or other entities communicatively coupled to the communication network 119 through the services platform 113. By way of example, the services platform 113 may also be other third-party services and include mapping services, navigation services, weather-based services, travel planning services, notification services, social networking services, content (e.g., audio, video, images, etc.) provisioning services, application services, storage services, contextual information determination services, location-based services, information-based services, etc. In one embodiment, the services platform 113 uses the output data generated by of the cloud-based platform 121 to provide services such as navigation, mapping, other location-based services, etc.

In one embodiment, the content providers 117a-117n (collectively referred to as content providers 117) may provide content or data (e.g., including geographic data, parametric representations of mapped features, etc.) to the UE 101, the vehicle 105, services platform 113, the cloud-based platform 121, the database 123, or the combination thereof. The content provided may be any type of content, such as map content, textual content, audio content, video content, image content, etc. In one embodiment, the content providers 117 may provide content that may aid in providing cloud-based verification of edge-based detection. In one embodiment, the content providers 117 may also store content associated with the UE 101, the vehicle 105, services platform 113, the cloud-based platform 121, the database 123, or the combination thereof. In another embodiment, the content providers 117 may manage access to a central repository of data, and offer a consistent, standard interface to data, such as a repository of the database 123.

The communication network 119 of system 100 includes one or more networks such as a data network, a wireless network, a telephony network, or any combination thereof. The data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In the illustrated embodiment, the cloud-based platform 121 may be a platform with multiple interconnected components. The cloud-based platform 121 may include multiple servers, intelligent networking devices, computing devices, components and corresponding software for providing cloud-based verification of edge-based detection. It should be appreciated that that the cloud-based platform 121 may be a separate entity of the system 100, included within the services platform 113 (e.g., as part of an application stored in server memory for the services platform 113), included within the content providers 117 (e.g., as part of an application stored in server memory for the content providers 117), or a combination thereof.

The cloud-based platform 121 is capable of: (1) receiving request for classifying sensor data acquired from the vehicle 105; (2) classifying the sensor data; (3) providing a classification result to the vehicle 105; and (4) generating and/or updating a map layer defining one or more events in which the vehicle 105 has transmitted the request. For each request received, the cloud-based platform 121 determines a type of predetermined condition that was satisfied for causing the vehicle 105 to transmit the request. If the type of predetermined condition is define by an event in which a confidence of an edge-based detection indicates uncertainty or a delta between an edge-based detection and map data is substantial, the cloud-based platform 121 generates a data point to indicate: (1) a location in which the vehicle 105 has acquired the sensor data; (2) time at which the vehicle 105 has acquired the sensor data; (3) the type of predetermined condition; (4) an edge-based detection result (e.g., confidence value of image classification performed by the vehicle 105, category of an object detected via image classification, etc.); and (5) a cloud-based verification result. The cloud-based platform 121 may generate one or more other data points for one or more other vehicles that are similar to vehicle 105 (i.e., including the data manager 155) and have generated requests for classifying sensor data acquired by the one or more other vehicles. Each data point generated and/or updated by the cloud-based platform 121 is recorded in the map layer.

As a plurality of data points is generated, the cloud-based platform 121 identifies learned locations. Each learned location indicates a location in which a plurality of vehicles have frequently requested cloud-based verification due to a confidence of an edge-based detection performed in the location indicating uncertainty or a delta between edge-based detection performed in the location and map data associated with the location being substantial. In one embodiment, the cloud-based platform 121 may provide the map layer including one or more data points and one or more learned locations to the UE 101 and/or the vehicle 105. In one embodiment, the cloud-based platform 121 may receive location data (e.g., GPS coordinates or a route of a vehicle) associated with other vehicles that are within one or more of the learned locations or are estimated to encounter the one or more of the learned locations. In such embodiment, the cloud-based platform 121 may transmits to such vehicles and/or UE associated therewith, a message that: (1) informing the learned locations; and (2) recommends whether the users wishes to cause the vehicles to transmit sensor data to the cloud-based platform 121 for cloud-based verification when the vehicles traverse one of the learned locations. Alternatively, the cloud-based platform 121 may transmit a command that causes the other vehicles to automatically transmit sensor data acquired at one or more of the learned locations for cloud-based verification without requiring the other vehicles to classify sensor data at the one or more of the learned locations.

In one embodiment, the cloud-based platform 121 uses a machine learning model to predict locations in which a confidence of an edge-based detection indicates uncertainty or a delta between an edge-based detection and map data is substantial. In such embodiment, the machine learning model is trained based on historical data, where the historical data are defined at least in part by the plurality of data points. The historical data includes contextual information associated with each of a plurality of data points. The contextual information indicates: (1) a time of day associated with a data point; (2) a weather condition associated with the time; (3) light attributes associated with a location of the data point (e.g., a contrast level of light, an intensity level of light, a temperature level of light, etc.); (4) a type of road associated with the location; (5) road attributes associated with the data point (e.g., a length, width, gradient, and/or curvature of a road segment, etc.); (6) physical objects within t as indicated by map data and the sensor data (e.g., POIs, road objects such as lane markings, barriers, medians, road signs, poles, posts, etc.); (7) positions and orientations of such physical objects; (8) relative positions of the physical objects with respect to one or more road segments; or (9) a combination thereof. Once the machine learning model is trained, the cloud-based platform 121 uses the machine learning model to: (1) identify locations having attributes that correspond to the historical data; and (2) for each of the locations, predict a likelihood of a predetermined event occurring therein, where the predetermined event is an event in which an edge-based detection indicates uncertainty or a delta between an edge-based detection and map data is substantial. If the likelihood exceeds a threshold, the cloud-based platform 121: (1) identifies one or more vehicles that is within the location or is estimated to encounter the location; and (2) automatically causes the one or more vehicles to transmit sensor data acquired at the location to the cloud-based platform 121 for cloud-based verification of the sensor data.

The cloud-based platform 121 is also capable of providing the data manager 155 to other vehicles similar to the vehicle 105 and updating the data manager 155 to improve edge-based detections. Software components for performing image classification and/or audio classification may be continuously updated at the of the cloud-based platform 121. Accordingly, the cloud-based platform 121 may update the data manager 155 based on the updated software components, thereby improving edge-based detections performed by vehicles including the data manager 155.

In the illustrated embodiment, the database 123 stores any multiple types of information that can provide means for aiding in providing cloud-based verification of edge-based detections. The database 125 may store information on road links (e.g., road type, road length, road breadth, slope information, lane information, curvature information, etc.), road nodes, probe data for one or more road links (e.g., traffic density information), POls, location and attribute information associated with one or more light generating devices, etc. It should be appreciated that the information stored in the database 123 may be acquired from any of the elements within the system 100, other vehicles, sensors, database, or a combination thereof. Contents of the database 123 will be further described in detail with reference to FIG. 1B.

In one embodiment, the UE 101, the vehicle 105, the services platform 113, the content providers 117, and the cloud-based platform 121 communicate with each other via the communication network 119 using well known, new or still developing protocols. In this context, a protocol includes a set of rules defining how the network nodes within the communication network 119 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises: (1) header information associated with a particular protocol; and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

FIG. 1B is a diagram of a database 123 (e.g., a map database), according to one embodiment. In one embodiment, the database 123 includes geographic data 1230 used for (or configured to be compiled to be used for) mapping and/or navigation-related services. In one embodiment, the following terminology applies to the representation of geographic features in the database 123.
a. “Node”—A point that terminates a link.
b. “Road segment”—A straight line connecting two points.
c. “Link” (or “edge”)—A contiguous, non-branching string of one or more road segments terminating in a node at each end.

In one embodiment, the database 123 follows certain conventions. For example, links do not cross themselves and do not cross each other except at a node. Also, there are no duplicated shape points, nodes, or links. Two links that connect each other have a common node.

As shown, the database 123 includes node data records 1231, road segment or link data records 1233, POI data records 1235, verification event records 1237, other records 1239, and indexes 1241, for example. More, fewer or different data records can be provided. In one embodiment, additional data records (not shown) can include cartographic (“carto”) data records, routing data, and maneuver data. In one embodiment, the indexes 1241 may improve the speed of data retrieval operations in the database 123. In one embodiment, the indexes 1241 may be used to quickly locate data without having to search every row in the database 123 every time it is accessed.

In exemplary embodiments, the road segment data records 1233 are links or segments representing roads, streets, or paths, as can be used in the calculated route or recorded route information for determination of one or more personalized routes. The node data records 1231 are end points (such as intersections) corresponding to the respective links or segments of the road segment or link data records 1233. The node data records 1231 may indicate node type, node size, a number of intersecting road segments or links, lane information, traffic control information, or a combination thereof. The road segment or link data records 1233 and the node data records 1231 represent a road network, such as used by vehicles, cars, and/or other entities. Alternatively, the database 123 can contain path segment and node data records or other data that represent pedestrian paths or areas in addition to or instead of the vehicle road record data, for example.

Links, segments, and nodes can be associated with attributes, such as geographic coordinates, street names, address ranges, speed limits, turn restrictions at intersections, variance types, and other attributes, as well as POls, such as gasoline stations, hotels, restaurants, museums, stadiums, offices, automobile dealerships, auto repair shops, stores, other buildings, parks, tunnels, etc. The database 123 can include data about the POls and their respective locations in the POI data records 1235. The data about the POls may include data about places, such as cities, towns, or other communities, and other geographic features, such as bodies of water, mountain ranges, etc. Such place or feature data can be part of the POI data records 1235 or can be associated with POls or POI data records 1235 (such as a data point used for displaying or representing a position of a city).

In one embodiment, the database 123 includes verification event records 1237. The verification event records include a map layer defines one or more events in which vehicles have transmitted a request for cloud-based verification of edge-based detections performed by the vehicles. The map layer includes a plurality of data points, where each data point indicates: (1) a location in which a vehicle has acquired the sensor data; (2) time at which the vehicle has acquired the sensor data; (3) a type of predetermined condition that was satisfied for causing the vehicle to transmit the request; (4) an edge-based detection result; and (5) a cloud-based verification result. The data point may also be associated contextual information indicating: (1) a weather condition associated with the time; (2) light attributes associated with the location; (3) physical objects within the location as indicated by map data and the sensor data; or (4) a combination thereof. The may layer may also include one or more learned locations, one or more locations that is predicted to induce an event in which an edge-based detection indicates uncertainty or a delta between an edge-based detection and map data is substantial.

Other records 1239 may include, for one or more locations within or proximate to a road network: (1) one or more traffic-based object (e.g., a road sign, road barriers, road markings, traffic lights, etc.); (2) a non-traffic-based object (e.g., a street light, a bus stop, a mailbox, etc.); (3) historical sound events; or (4) a combination thereof. The other records 1239 may further include computer program instructions for causing a machine learning model to predict locations in which a confidence of an edge-based detection indicates uncertainty or a delta between an edge-based detection and map data is substantial. The other records 1239 may also include: (1) software components defining the data manager 155; (2) a list of vehicles that include the software component of the data manager 155; or (3) a combination thereof.

In one embodiment, the database 123 can be maintained by one or more of the content providers 117 in association with a map developer. The map developer can collect geographic data 1230 to generate and enhance the database 123. There can be different ways used by the map developer to collect data. These ways can include obtaining data from other sources, such as municipalities or respective geographic authorities. In addition, the map developer can employ field personnel to travel by vehicle along roads throughout the geographic region to observe road signs and/or record information about them, for example. Also, remote sensing, such as aerial or satellite photography, can be used.

The database 123 can be a master database stored in a format that facilitates updating, maintenance, and development. For example, the master database or data in the master database can be in an Oracle spatial format or other spatial format (e.g., accommodating different map layers), such as for development or production purposes. The Oracle spatial format or development/production database can be compiled into a delivery format, such as a geographic data files (GDF) format. The data in the production and/or delivery formats can be compiled or further compiled to form database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by the vehicle 105, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received database in a delivery format to produce one or more compiled navigation databases.

The processes described herein for providing cloud-based verification of edge-based detection may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

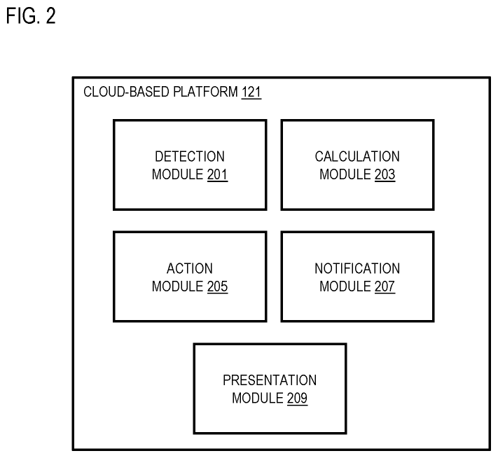

FIG. 2 is a diagram of the components of the cloud-based platform 121, according to one embodiment. By way of example, the cloud-based platform 121 includes one or more components for providing cloud-based verification of edge-based detection. It is contemplated that the functions of these components may be combined in one or more components or performed by other components of equivalent functionality. In this embodiment, the cloud-based platform 121 includes a detection module 201, a calculation module 203, an action or control module 205, a notification module 207, and a presentation module 209.

The detection module 201 is capable of receiving requests for classifying edge-based detections conducted by the vehicle 105. In one embodiment, the detection module 201 acquires information indicating: (1) a location in which the vehicle 105 has acquired sensor data; (2) time at which the vehicle 105 has acquired the sensor data; (3) a type of predetermined condition that was satisfied for causing the vehicle 105 to transmit the request; and (4) an edge-based detection result. Such information may be acquired from the vehicle 105, map data stored in the database 123, or a combination thereof.

In one embodiment, the detection module 201 is capable of performing one or more functions associated with the data manager 155. In such embodiment, the detection module 201 may use map data and location data associated with the vehicle 105 to determine whether the vehicle 105 is within or is estimated to encounter a predetermined road segment including a complex road geometry, such as an intersection, a ramp, or parallel road arrangement. In one embodiment, the detection module 201 may determine whether the vehicle 105 is traversing a road segment impacted by an adverse weather condition, such as fog, heavy rain, snowstorm, etc. In one embodiment, the detection module 201 determines a time of day at which the vehicle 105 is traversing a road segment. Such information may be processed by the calculation module 203 and used by the action module 205 to generate a command that causes the vehicle 105 to transmit sensor data to the cloud-based platform 121 for cloud-based verification.

The calculation module 203 is capable of: (1) classifying sensor data acquired by the vehicle 105 to generate a classification result; (2) generating and/or updating a map layer defining one or more events in which the vehicle 105 has transmitted the request; (3) identifying one or more learned locations within the map layer; and (4) predicting one or more events in which a confidence of an edge-based detection indicates uncertainty or a delta between an edge-based detection and map data is substantial. The classification result provides a classification of a specific portion of the sensor data as a discernible category and indicates a confidence at which the specific portion of the sensor data is classified as the discernible category.

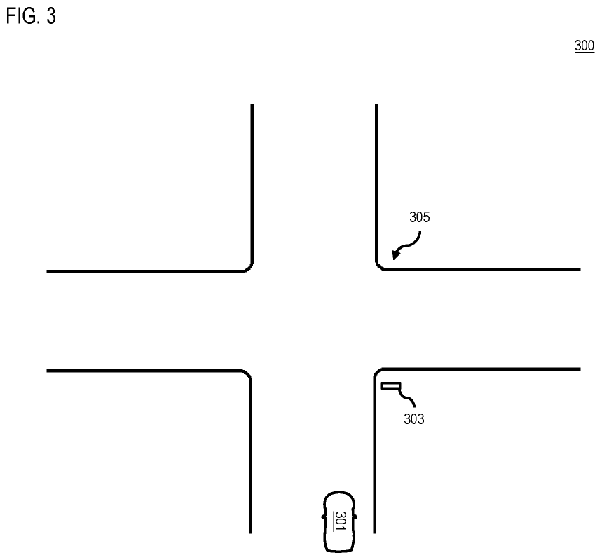

Once a request for cloud-based verification is received by the detection module 201 from the vehicle 105 and the type of predetermined condition is identified by the detection module 201, the calculation module 203 determines whether the type of predetermined condition is defined by an event in which: (1) a confidence of an edge-based detection indicates uncertainty; or (2) a delta between an edge-based detection and map data is substantial. If so, the calculation module 203 generates a data point for the map layer to indicate: (1) the location in which the vehicle 105 has acquired the sensor data; (2) the time at which the vehicle 105 has acquired the sensor data; (3) the type of predetermined condition; (4) the edge-based detection result; and (5) the cloud-based verification result. For example, FIG. 3 illustrates an example scenario 300 in which the calculation module 203 generates a data point associated with a request for cloud-based verification of edge-based detection. In the illustrated example, a vehicle 301 encounters a stop sign 303 at an intersection 305. The vehicle 301 is assumed to be similar to the vehicle 105, includes a data manager 155, and is communicatively coupled to the cloud-based platform 121. The vehicle 301 uses an image sensor (not illustrated) to observe the stop sign 303. The vehicle 301 performs an edge-based detection to classify images captured by the image sensor and determines that a confidence at which the images indicate a stop sign is 65%. Since the confidence is within a range of 55% to 70%, the vehicle 301 determines that the vehicle 301 is uncertain whether a stop sign was observed at the intersection 305. As such, the vehicle 301 transmits a request for cloud-based verification, and the calculation module 203 performs the cloud-based verification and generates a data point indicating: (1) the location in which the vehicle 301 has acquired the images; (2) the time at which the vehicle 301 has acquired the images; (3) that the confidence indicates uncertainty; (4) the edge-based detection result; and (5) the cloud-based verification result. As a plurality of data points is generated, the calculation module 203 identifies one or more learned locations within the map layer. For example, returning to FIG. 3, if a plurality of vehicles encounters the stop sign 303 in a similar way as the vehicle 301, performs edge-based detections, respectively, and are also uncertain whether the stop sign 303 was observed by image sensors of the plurality of vehicles, the calculation module 203 marks the location of the intersection 305 as a learned location in a map layer.

In one embodiment, the calculation module 203 uses a machine learning model to predict locations in which a confidence of an edge-based detection indicates uncertainty or a delta between an edge-based detection and map data is substantial. In such embodiment, the machine learning model is trained based on historical data, where the historical data are defined at least in part by the plurality of data points. The historical data includes contextual information associated with each of a plurality of data points. The contextual information indicates: (1) a time of day associated with a data point; (2) a weather condition associated with the time; (3) light attributes associated with a location of the data point (e.g., a contrast level of light, an intensity level of light, a temperature level of light, etc.); (4) a type of road associated with the location; (5) road attributes associated with the data point (e.g., a length, width, gradient, and/or curvature of a road segment, etc.); (6) physical objects within t as indicated by map data and the sensor data (e.g., POls, road objects such as lane markings, barriers, medians, road signs, poles, posts, etc.); (7) positions and orientations of such physical objects; (8) relative positions of the physical objects with respect to one or more road segments; or (9) a combination thereof. Once the machine learning model is trained, the calculation module 203 uses the machine learning model to: (1) identify locations having attributes that correspond to the historical data; and (2) for each of the locations, predict a likelihood of which an edge-based detection performed in the location indicates uncertainty or a delta between an edge-based detection and map data is substantial. Such contextual information may be acquired by the detection module 201. Specifically, the detection module 201 may be in communication with one or more sensors (e.g., vehicle sensors, stationary sensors, traffic cameras, etc.) that is within a location associated with each of the plurality of data points and derive the contextual information based on sensor data acquired from the one or more sensors.

The action module 205 is capable of: (1) providing the classification result to the vehicle 105; (2) providing a command that causes the vehicle 105 or one or more other similar vehicles including the data manager 155 to automatically transmit sensor data to the cloud-based platform 121 in response to the vehicle 105 or the one or more other vehicles being within or encountering a learned location; (3) providing a command that causes the vehicle 105 or one or more other similar vehicles including the data manager 155 to automatically transmit sensor data to the cloud-based platform 121 in response to the vehicle 105 or the one or more other vehicles encountering a location in which a confidence of an edge-based detection is predicted to indicate uncertainty or a delta between an edge-based detection and map data is predicted to be substantial. The action module 205 may also provide the data manager 155 to one or more vehicles communicatively coupled to the cloud-based platform 121 via the communication network 119.

The notification module 207 may cause a notification to the UE 101, other notification devices within the vehicle 105, local municipalities, or other establishments. In one embodiment, the notification may indicate: (1) a request for cloud-based verification of edge-based detection from the vehicle 105; (2) a time at which sensor data is acquired by the vehicle 105; (2) a time at which the request is transmitted by the vehicle 105; (3) a classification result output by the calculation module 203; (4) whether the vehicle 105 is traversing or is estimated to encounter a learned location; or (5) whether the vehicle 105 is traversing or is estimated to encounter a location in which a confidence of an edge-based detection is predicted to indicate uncertainty or a delta between an edge-based detection and map data is predicted to be substantial. The notification may be generated as a sound notification, display notification, vibration, or a combination thereof.

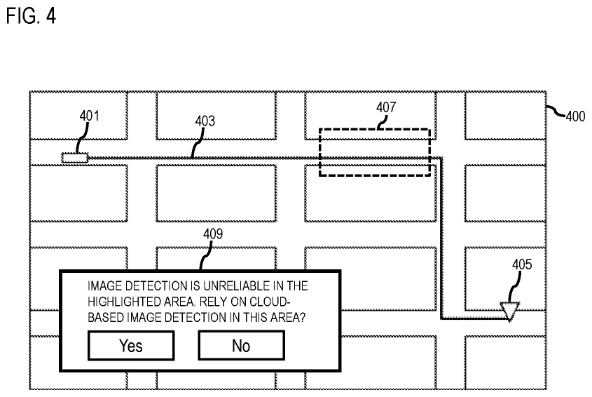

The presentation module 207 obtains a set of information, data, and/or calculated results from other modules, and continues with providing a presentation of a visual representation to the UE 101. The visual representation may indicate any of the information presented by the notification module 205. For example, FIG. 4 illustrates an example visual representation 400 rendered by the presentation module 207. In the illustrated embodiment, the example visual representation 400 is a map including a representation of a vehicle 401, a route 403, a destination 405, a highlighted portion 407, and a message 409. In the illustrate embodiment, the highlighted portion 407 is a learned location. As such, the presentation module 207 has generated the selectable message 409 stating “IMAGE DETECTION IS UNRELIABLE IN THE HIGHLIGHTED AREA. RELY ON CLOUD-BASED IMAGE DETECTION IN THIS AREA?” and including a “YES” and “NO” prompt. In alternative embodiments, the visual representation may be provided without a route, thereby enabling a user to freely observe one or more learned locations. In one embodiment, the visual representation may be presented as a combination of map layers including a map layer including one or more learned locations and other map layers indicating other information such road link, segment, node information, POI information, a type of weather affecting one or more areas, etc.

The above presented modules and components of the cloud-based platform 121 can be implemented in hardware, firmware, software, or a combination thereof. Though depicted as a separate entity in FIG. 2, it is contemplated that the cloud-based platform 121 may be implemented for direct operation by the services platform 113, one or more of the content providers 117, or a combination thereof. As such, the cloud-based platform 121 may generate direct signal inputs by way of the operating system of the services platform 113, the one or more of the content providers 117, or the combination thereof for interacting with the applications 103. The various executions presented herein contemplate any and all arrangements and models.

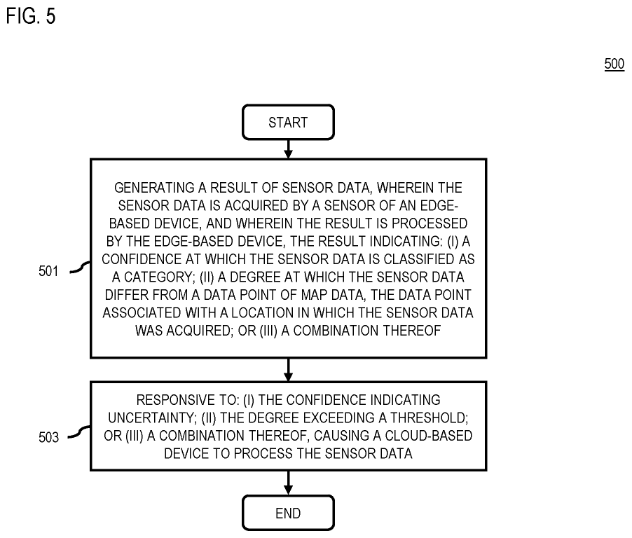

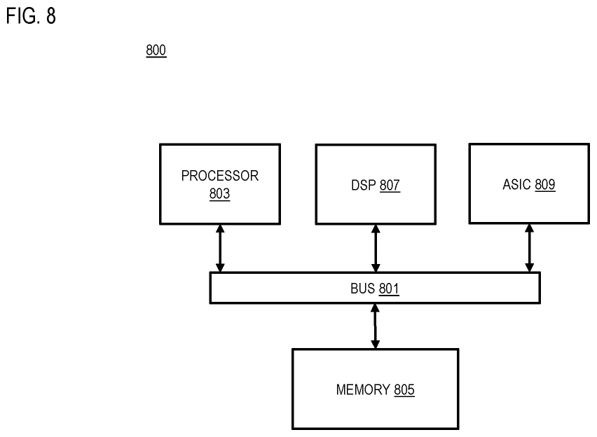

FIG. 5 is a flowchart of a process 500 for causing a cloud-based device to process sensor data based on a result output by an edge-based device, according to one embodiment. In one embodiment, the data manager 155 performs the process 500 and is implemented in, for instance, a chip set including a processor and a memory as shown in FIG. 8.

In step 501, the data manager 155 generates a result of sensor data that is acquired by a sensor of an edge-based device. For example, the sensor may be the sensor 107, and the edge-based device may be the vehicle 105. The sensor data may be image data acquired by image sensors of the sensors 107 or audio data acquired by audio recorders of the sensors 107. The data manager 155 may process the sensor data and generate the result. In one embodiment, the result indicates a confidence at which the sensor data is classified as a category discernible by a machine and/or a human. Additionally or alternatively, the result indicates a degree at which the sensor data differ from a data point of map data, where the data point is associated with a location in which the sensor data was acquired. For example, the result may emphasize a difference between road observation data (e.g., what is observed by an image sensor of a vehicle) and map data (e.g., what is recorded in the map data at the location in which the road observation data were acquired).

In step 503, if the data manager 155 determines that: (i) the confidence indicates uncertainty; (ii) the degree exceeds a threshold; or (iii) a combination thereof, the data manager 155 causes a cloud-based device to process the sensor data. In one embodiment, if a value associated with the confidence is within a range (e.g., 55% to 70%), the data manager 155 determines that the confidence indicates uncertainty. In one embodiment, the degree exceeding a threshold may be defined by an event in which: (1) an image sensor of a vehicle observes a speed limit sign of 50kph at a location; and (2) map data indicates a speed limit sign of 100 kph at the location. The data manager 155 may cause the cloud-based device, such as the cloud-based platform 121, to process the sensor data by transmitting a request to the cloud-based device.

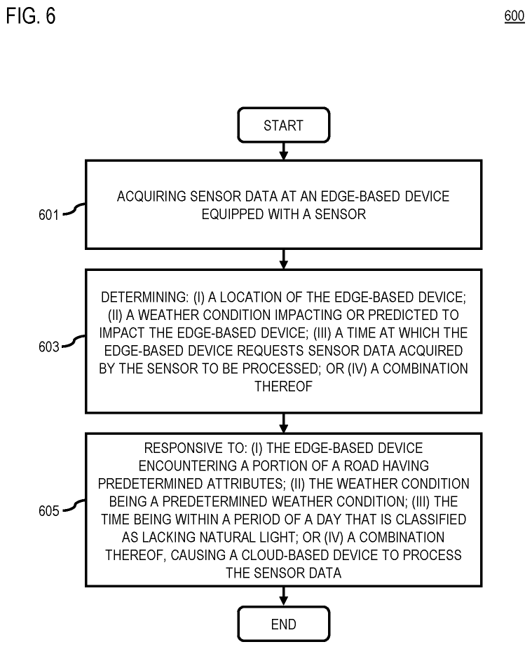

FIG. 6 is a flowchart of a process 600 for causing a cloud-based device to process sensor data based on one or more environmental conditions, according to one embodiment. In one embodiment, the data manager 155 performs the process 600 and is implemented in, for instance, a chip set including a processor and a memory as shown in FIG. 8.

In step 601, the data manager 155 acquires sensor data at an edge-based device equipped with a sensor. The edge-based device may be the vehicle 105, the sensor may be an image sensor or an audio recorder of the sensors 107, and the sensor data may be image data or audio data.

In step 603, the data manager 155 determines: (i) a location of the edge-based device; (ii) a weather condition impacting or predicted to impact the edge-based device; (iii) a time at which the edge-based device requests sensor data acquired by the sensor to be processed; or (iv) a combination thereof. The data manger 155 may render such determination by: (i) acquiring location data associated with the vehicle 105; (ii) acquiring weather forecast data associated with the location data; or (iii) referring to an internal clock maintained by the vehicle 105.

In step 605, if the data manager 155 determines that: (i) the edge-based device is encountering a portion of a road having predetermined attributes; (ii) the weather condition is a predetermined weather condition; (iii) the time is within a period of a day that is classified as lacking natural light; or (iv) a combination thereof, the data manager 155 causes a cloud-based device to process the sensor data. The cloud-based device may be the cloud-based platform 121. In one embodiment, if the portion of the road is: (i) an intersection; (ii) a ramp; or (iii) one of parallel roads, the data manager 155 causes a cloud-based device to process the sensor data. In one embodiment, if the weather condition indicates: (i) a rainstorm; (ii) a fog; (iii) a snowstorm; or (iv) a combination thereof, the data manager 155 causes a cloud-based device to process the sensor data. In one embodiment, the data manager 155 may determine a period of a day that is classified as lacking natural light based on historical data. The historical data may indicate a period of each of a plurality of past days in which daytime transitions into night-time.

The processes described herein may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

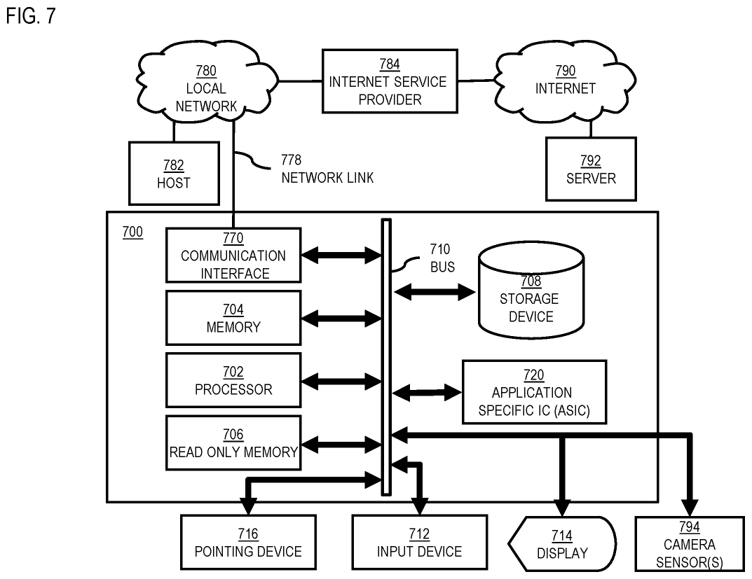

FIG. 7 illustrates a computer system 700 upon which an embodiment may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to provide cloud-based verification of edge-based detection as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for providing cloud-based verification of edge-based detection.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to providing cloud-based verification of edge-based detection. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 700 also includes a memory 704 coupled to bus 710. The memory 704, such as a random access memory (RAM) or any other dynamic storage device, stores information including processor instructions for providing cloud-based verification of edge-based detection. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for providing cloud-based verification of edge-based detection, is provided to the bus 710 for use by the processor from an external input device 712, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714, and one or more camera sensors 794 for capturing, recording and causing to store one or more still and/or moving images (e.g., videos, movies, etc.) which also may comprise audio recordings. In some embodiments, for example, in embodiments in which the computer system 700 performs all functions automatically without human input, one or more of external input device 712, display device 714 and pointing device 716 may be omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 119 for providing cloud-based verification of edge-based detection to the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 782 connected to the Internet hosts a process that provides a service in response to information received over the Internet. For example, server host 782 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 782 transmits program code for a particular application, requested by a message sent from computer 700, through Internet 790, ISP equipment 784, local network 780 and communications interface 770. The received code may be executed by processor 702 as it is received or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment may be implemented. Chip set 800 is programmed to provide cloud-based verification of edge-based detection, as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for providing cloud-based verification of edge-based detection.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 800 includes merely one or more processors and some software and/or firmware supporting and/or relating to and/or for the one or more processors. The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to provide cloud-based verification of edge-based detection. The memory 805 also stores the data associated with or generated by the execution of the inventive steps.

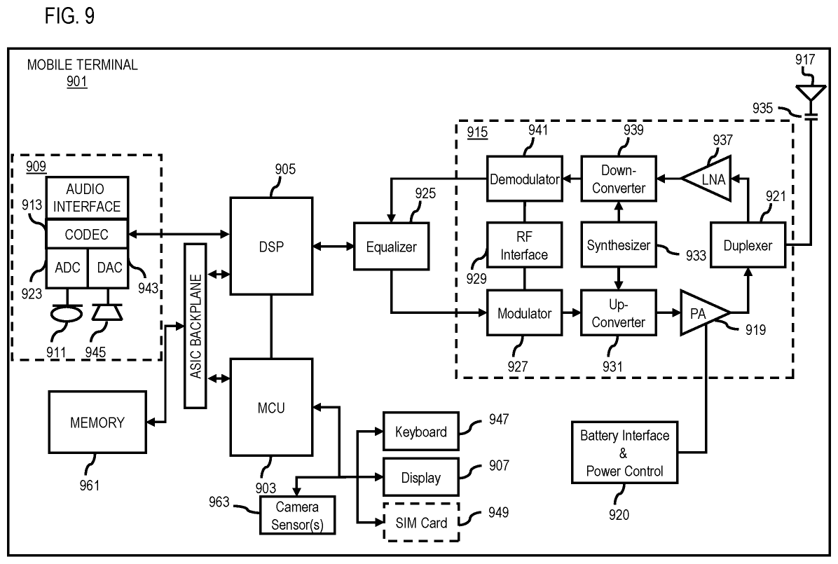

FIG. 9 is a diagram of exemplary components of a mobile terminal 901 (e.g., a mobile device or vehicle or part thereof) for communications, which is capable of operating in the system of FIG. 1A, according to one embodiment. In some embodiments, mobile terminal 901, or a portion thereof, constitutes a means for providing cloud-based verification of edge-based detection. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of providing cloud-based verification of edge-based detection. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G networks, code division multiple access (CDMA), wideband code division multiple access (WCDMA), wireless fidelity (WiFi), satellite, and the like, or any combination thereof.

The encoded signals are then routed to an equalizer 921 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 1317 and immediately amplified by a low noise amplifier (LNA) 937. A down-converter 939 lowers the carrier frequency while the demodulator 941 strips away the RF leaving only a digital bit stream. The signal then goes through the equalizer 921 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to provide cloud-based verification of edge-based detection. The MCU 903 also delivers a display command and a switch command to the display 907 and to the speech output switching controller, respectively. Further, the MCU 903 exchanges information with the DSP 905 and can access an optionally incorporated SIM card 949 and a memory 961. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 99 includes the ADC 923 and DAC 943. The memory 961 stores various data including call incoming tone data and is capable of storing other data including music data received via, e.g., the global Internet. The software module could reside in RAM memory, flash memory, registers, or any other form of writable storage medium known in the art. The memory device 961 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

Further, one or more camera sensors 963 may be incorporated onto the mobile station 901 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. An apparatus comprising at least one processor and at least one non-transitory memory including computer program code instructions, the computer program code instructions configured to, when executed, cause the apparatus to:
generate a result of sensor data, wherein the sensor data is acquired by a sensor of an edge-based device, the result indicating a degree at which the sensor data differ from a data point of map data, the data point associated with a location in which the sensor data was acquired; and
responsive to the degree exceeding a threshold, cause a cloud-based device to process the sensor data.

2. The apparatus of claim 1, wherein the edge-based device is a vehicle.

3. The apparatus of claim 1, wherein the sensor is an image sensor, and the result is derived from image processing performed by the edge-based device.

4. The apparatus of claim 1, wherein the sensor data include one or more images of an object proximate to the location, wherein the data point indicates attributes of the object, and wherein the degree indicates a difference between the object in the one or more images and the data point.

5. The apparatus of claim 1, wherein the sensor is an audio sensor, and the result is derived from audio processing performed by the edge-based device.

6. The apparatus of claim 5, wherein the sensor data include audio data, wherein the data point indicates attributes of a sound event within the location, and wherein the degree indicates a difference between the audio data and the data point.

7. (canceled)

8. (canceled)

9. The apparatus of claim 1, wherein the computer program code instructions are configured to, when executed, cause the apparatus to, responsive to the degree exceeding the threshold, cause the cloud-base device to:
acquire one or more other sensor data acquired from one or more other sensors of one or more other edge-based devices that are proximate to the edge-based device; and
process the one or more other sensor data.

10. The apparatus of claim 1, wherein the edge-based device stores a machine learning model for processing the result, and wherein the computer program code instructions are configured to, when executed, cause the apparatus to cause the cloud-based device to:
transmit cloud-based computations to the edge-based device, wherein the cloud-based computations are generated by the cloud-based device as a function of the sensor data; and
cause the edge-based device to update the machine learning model based on the cloud-based computations.

11. The apparatus of claim 1, and wherein the computer program code instructions are configured to, when executed, cause the apparatus to, responsive to the degree exceeding the threshold:
receive location information associated with one or more other edge-based vehicles devices equipped with one or more other sensors;
based on the location information, determine proximity of the one or more other edge-based devices with respect to the first location; and
responsive to the one or more other edge-based devices being at the first location, cause the cloud-based device to process one or more other sensor data acquired by the one or more other sensors.

12-20. (canceled)

21. The apparatus of claim 1, wherein the result further indicates a confidence at which the sensor data is classified as a category, and wherein the computer program code instructions are configured to, when executed, cause the apparatus to, responsive to the confidence indicating uncertainty, cause the cloud-based device to process the sensor data.

22. The apparatus of claim 21, wherein the confidence is associated with a confidence value, and wherein the computer program code instructions are configured to, when executed, cause the apparatus to define the confidence as being uncertain in response to the confidence value being greater than a first non-zero threshold and less than a second threshold greater than the first threshold hold.

23. The apparatus of claim 21, wherein the confidence is associated with a confidence value, and wherein the computer program code instructions are configured to, when executed, cause the apparatus to define the confidence as being uncertain in response to the confidence value being less than 70 percent.

24. A non-transitory computer-readable storage medium having computer program code instructions stored therein, the computer program code instructions, when executed by at least one processor, cause the at least one processor to:
generate a result of sensor data, wherein the sensor data is acquired by a sensor of an edge-based device, the result indicating a degree at which the sensor data differ from a data point of map data, the data point associated with a location in which the sensor data was acquired; and
responsive to the degree exceeding a threshold, cause a cloud-based device to process the sensor data.

25. The non-transitory computer-readable storage medium of claim 24, wherein the edge-based device is a vehicle.

26. The non-transitory computer-readable storage medium of claim 24, wherein the sensor is an image sensor, and the result is derived from image processing performed by the edge-based device.

27. The non-transitory computer-readable storage medium of claim 24, wherein the sensor data include one or more images of an object proximate to the location, wherein the data point indicates attributes of the object, and wherein the degree indicates a difference between the object in the one or more images and the data point.

28. A method of causing a cloud-based device to process sensor data based on a result output by an edge-based device, the method comprising:
generating the result of the sensor data, wherein the sensor data is acquired by a sensor of the edge-based device, the result indicating a degree at which the sensor data differ from a data point of map data, the data point associated with a location in which the sensor data was acquired; and
responsive to the degree exceeding a threshold, causing the cloud-based device to process the sensor data.

29. The method of claim 28, wherein the edge-based device is a vehicle.

30. The method of claim 28, wherein the sensor is an image sensor, and the result is derived from image processing performed by the edge-based device.

31. The method of claim 28, wherein the sensor data include one or more images of an object proximate to the location, wherein the data point indicates attributes of the object, and wherein the degree indicates a difference between the object in the one or more images and the data point.
